(19) United States
(12) Patent Application Publication
(10) Pub. No.: US 2025/0024373 A1
(43) Pub. Date: Jan. 16, 2025

(54) EARLY ACKNOWLEDGEMENT FOR DATA TRANSMITTED FROM WIRELESS DEVICE

(71) Applicant: Telefonaktiebolaget LM Ericsson (publ), Stockholm (SE)

(72) Inventors: Amin AZARI, Järfälla (SE); Hossein SHOKRI GHADIKOLAEI, Täby (SE); Jaeseong JEONG, Solna (SE)

(21) Appl. No.: 18/712,147

(22) PCT Filed: Dec. 1, 2021
(86) PCT No.: PCT/EP2021/083809

§ 371 Date: May 21, 2024

(51) Int. Cl. H04W 52/02; H04L 1/1607

(52) U.S. Cl. CPC H04W 52/0235; H04L 1/1607

(57) ABSTRACT

A node of a wireless communication network receives a transmission of data from a wireless device. Further, the node sends an early acknowledgement message to the wireless device. The early acknowledgement message indicates that the node will handle delivery of the data to a destination device on behalf of the wireless device.

### TECHNICAL FIELD

The present invention relates to methods for controlling wireless transmissions and to corresponding devices, systems, and computer programs.

### BACKGROUND

In wireless communication networks, e.g., based on the 4G (4^{th} Generation) LTE (Long Term Evolution) or 5G (5^{th} Generation) NR technology as specified by 3GPP (3^{rd} Generation Partnership Project), there is a general need to operate wireless devices, typically referred to as UE (user equipment), in an energy-efficient manner. This particularly applies to IoT (Internet of Things) and other MTC (Machine Type Communication) devices, which are often subject to resource constraints.

While enhanced energy saving for MTC enables providing connectivity for more devices types, motivation for reducing energy consumption goes beyond enabling new MTC use-cases. In order to improve energy efficiency of MTC in existing systems, mobile communication networks often devote extra power and extra radio resources to MTC. For example, in the case of NB-IoT (Narrow Band IoT), repeated transmissions may be used in order to increase probability of successful data transfer. WO 2019/066688 A1 describes utilization of relaxed synchronization and semi grant-free access to radio resources for saving energy of battery critical devices.

In some cases, a potential need for re-transmissions may also contribute to energy consumption of MTC. When for example considering E2E (end-to-end) connectivity of IoT devices as illustrated in FIG. 1, it can be seen that the IoT device connects to a RAN (Radio Access Network), which in turn is connected through a core network (in FIG. 1 assumed to be a 4G/5G core) to IoT application servers, in the illustrated example an IoT controller and an AAA (Authentication, Authorization, and Accounting) server. The IoT devices may be constrained devices which have only some bits of data to send to the IoT servers, e.g., an alive signal. This could be done using a CoAP (Constrained Application Protocol) transport protocol, in which there is no hand shake between transmitter and receiver. In such scenarios, the wireless communication network may act as a pipeline between the IoT device and the IoT application server, which means that the wireless communication network is not aware of the data content transferred through the wireless communication network. In some cases, the data could also be E2E encrypted. Further, also when using a CoAP transport protocol or other type of delay tolerant communication, acknowledgements between the IoT device and the IoT application server can be used for ensuring the successful transfer of data from the IoT device to the IoT server. In some cases, there may be a considerable delay between a transmission of data by the IoT device and reception of an acknowledgement message for the data from the IoT server. During this delay, the IoT device may still need to continuously monitor the radio channel for the acknowledgement message. Further, in cases where the other endpoint of communication is another IoT device, and not an IoT application server, it could happen that the IoT device to which the data shall be transferred is not reachable when the transmitted data arrives through the wireless communication network. With existing mechanisms, this may result in failure of successful transfer of the data to its destination, and typically a subsequent retransmission of the data. Such retransmission of the data would in turn adversely affect energy efficiency of the transmitting IoT device.

Accordingly, there is a need for techniques which allow for efficiently handling transmissions of data requiring response from a remote communication endpoint.

### SUMMARY

According to an embodiment, a method of controlling wireless communication is provided. According to the method, a node of a wireless communication network receives a transmission of data from a wireless device. Further, the node sends an early acknowledgement message to the wireless device. The early acknowledgement message indicates that the node will handle delivery of the data to a destination device on behalf of the wireless device.

According to a further embodiment, a method of controlling wireless communication is provided. According to the method, a wireless device sends a transmission of data through a wireless communication network to a destination device. Further, the wireless device receives an early acknowledgement message from a node of the wireless communication network. The early acknowledgement message indicating that the node will handle delivery of the data to the destination device on behalf of the wireless device.

According to a further embodiment, a method of controlling wireless communication is provided. According to the method, a node of a wireless communication network provides control information to a further node of the wireless communication network. The control information configures the further node to receive a transmission of data from a wireless device, send an early acknowledgement message to the wireless device, the early acknowledgement message indicating that the further node will handle delivery of the data to a destination device on behalf of the wireless device, and forward the data to the destination device.

According to a further embodiment, a node for a wireless communication network is provided. The node is configured to receive a transmission of data from a wireless device. Further, the node is configured to send an early acknowledgement message to the wireless device. The early acknowledgement message indicates that the node will handle delivery of the data to a destination device on behalf of the wireless device.

According to a further embodiment, a node for a wireless communication network is provided. The node comprises at least one processor and a memory. The memory contains instructions executable by said at least one processor, whereby the node is operative to receive a transmission of data from a wireless device. Further, the memory contains instructions executable by said at least one processor, whereby the node is operative to send an early acknowledgement message to the wireless device. The early acknowledgement message indicates that the node will handle delivery of the data to a destination device on behalf of the wireless device.

According to a further embodiment, a wireless device for operation in a wireless communication network is provided. The wireless device is configured to send a transmission of data through a wireless communication network to a destination device. Further, the wireless device is configured to receive an early acknowledgement message from a node of the wireless communication network. The early acknowledgement message indicates that the node will handle delivery of the data to the destination device on behalf of the wireless device.

According to a further embodiment, a wireless device for operation in a wireless communication network is provided. The wireless device comprises at least one processor and a memory. The memory contains instructions executable by said at least one processor, whereby the wireless device is operative to send a transmission of data through a wireless communication network to a destination device. Further, the memory contains instructions executable by said at least one processor, whereby the wireless device is operative to receive an early acknowledgement message from a node of the wireless communication network. The early acknowledgement message indicates that the node will handle delivery of the data to the destination device on behalf of the wireless device.

According to a further embodiment, a node for a wireless communication network is provided. The node is configured to provide control information to a further node of the wireless communication network. The control information configures the further node to receive a transmission of data from a wireless device, and send an early acknowledgement message to the wireless device, the early acknowledgement message indicating that the further node will handle delivery of the data to a destination device on behalf of the wireless device.

According to a further embodiment, a node for a wireless communication network is provided. The node comprises at least one processor and a memory. The memory contains instructions executable by said at least one processor, whereby the node is operative to provide control information to a further node of the wireless communication network. The control information configures the further node to receive a transmission of data from a wireless device, and send an early acknowledgement message to the wireless device, the early acknowledgement message indicating that the further node will handle delivery of the data to a destination device on behalf of the wireless device.

According to a further embodiment of the invention, a computer program or computer program product is provided, e.g., in the form of a non-transitory storage medium, which comprises program code to be executed by at least one processor of a node for a wireless communication network. Execution of the program code causes the node to receive a transmission of data from a wireless device. Further, execution of the program code causes the node to send an early acknowledgement message to the wireless device. The early acknowledgement message indicates that the node will handle delivery of the data to a destination device on behalf of the wireless device.

According to a further embodiment of the invention, a computer program or computer program product is provided, e.g., in the form of a non-transitory storage medium, which comprises program code to be executed by at least one processor of a wireless device for operation in a wireless communication network. Execution of the program code causes the wireless device to send a transmission of data through a wireless communication network to a destination device. Further, execution of the program code causes the wireless device to receive an early acknowledgement message from a node of the wireless communication network. The early acknowledgement message indicates that the node will handle delivery of the data to the destination device on behalf of the wireless device.

According to a further embodiment of the invention, a computer program or computer program product is provided, e.g., in the form of a non-transitory storage medium, which comprises program code to be executed by at least one processor of a node for a wireless communication network. Execution of the program code causes the node to provide control information to a further node of the wireless communication network. The control information configures the further node to receive a transmission of data from a wireless device, and send an early acknowledgement message to the wireless device, the early acknowledgement message indicating that the further node will handle delivery of the data to a destination device on behalf of the wireless device.

Details of such embodiments and further embodiments will be apparent from the following detailed description of embodiments.

### BRIEF DESCRIPTION OF THE DRAWINGS

FIG. 1 illustrates and example of E2E communication between an IoT devices and IoT application servers.

FIG. 2 schematically illustrates a wireless communication network according to an embodiment.

FIG. 3A schematically illustrates an example involving utilization of an early acknowledgement according to an embodiment in communication between a wireless device and an application server.

FIG. 3B schematically illustrates an example involving utilization of an early acknowledgement according to an embodiment in communication between a wireless device and a further wireless device.

FIG. 4 schematically illustrates an example of processes according to an embodiment.

FIGS. 5A and 5B schematically illustrate user plane and control plane interaction in communication according to an embodiment.

FIG. 6 shows a flowchart for schematically illustrating a method according to an embodiment.

FIG. 7 shows an exemplary block diagram for illustrating functionalities of a network node implementing functionalities corresponding to the method of FIG. 6.

FIG. 8 shows a flowchart for schematically illustrating a further method according to an embodiment.

FIG. 9 shows an exemplary block diagram for illustrating functionalities of a wireless device implementing functionalities corresponding to the method of FIG. 8.

FIG. 10 shows a flowchart for schematically illustrating a method according to an embodiment.

FIG. 11 shows an exemplary block diagram for illustrating functionalities of a network node implementing functionalities corresponding to the method of FIG. 10.

FIG. 12 schematically illustrates structures of a wireless device according to an embodiment.

FIG. 13 schematically illustrates structures of a network node according to an embodiment.

### DETAILED DESCRIPTION

In the following, concepts in accordance with exemplary embodiments of the invention will be explained in more detail and with reference to the accompanying drawings. The illustrated embodiments relate to controlling of wireless communication by a wireless device (WD). The wireless communication network may be based on the 5G NR technology specified by 3GPP. However, other technologies could be used as well, e.g., the 4G LTE technology specified by 3GPP. The WD may correspond to various types of UEs or other types of WDs. As used herein, the term “wireless device” (WD) refers to a device capable, configured, arranged, and/or operable to communicate wirelessly with network nodes and/or other WDs. Unless otherwise noted, the term WD may be used interchangeably herein with UE. Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a Voice over IP (VoIP) phone, a wireless local loop phone, a desktop computer, a Personal Digital Assistant (PDA), a wireless camera, a gaming console or device, a music storage device, a playback appliance, a wearable terminal device, a wireless endpoint, a mobile station, a tablet, a laptop, Laptop Embedded Equipment (LEE), Laptop Mounted Equipment (LME), a smart device, a wireless Customer Premise Equipment (CPE), a vehicle mounted wireless terminal device, a connected vehicle, etc. In some examples, in an Internet of Things (IoT) scenario, a WD may also represent a machine or other device that performs monitoring and/or measurements, and transmits the results of such monitoring and/or measurements to another WD and/or a network node. The WD may in this case be a Machine-to-Machine (M2M) device, which may in a 3GPP context be referred to as a Machine-Type Communication (MTC) device. As one particular example, the WD may be a UE implementing the 3GPP Narrowband IoT (NB-IoT) standard. Particular examples of such machines or devices are sensors, metering devices such as power meters, industrial machinery, home or personal appliances (e.g., refrigerators, televisions, etc.), or personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

In the illustrated concepts, delivery of data is based on an early acknowledgement message. More specifically, when a wireless device sends a transmission of data through a wireless communication network to a destination device, a node of the wireless communication network sends an early acknowledgement message to the wireless device. The early acknowledgement message indicates that the node will handle the delivery of the data to the destination device to the destination device on behalf of the wireless device. This means that the node can take over certain protocol functionalities that otherwise would need to be performed by the wireless device. This may particularly include that the node buffers the data and, after forwarding the data to the destination device, the node waits for reception of a regular acknowledgement message from the destination device. In response to not receiving the regular acknowledgement message, the node can trigger a retransmission of the data. In response to receiving the regular acknowledgement message, the node can delete the data from its buffer and forward the regular acknowledgment message to the wireless device. In the case of successful transfer of the data to the destination device, the wireless device would thus typically receive two acknowledgement messages, the early acknowledgement message and later the regular acknowledgement message.

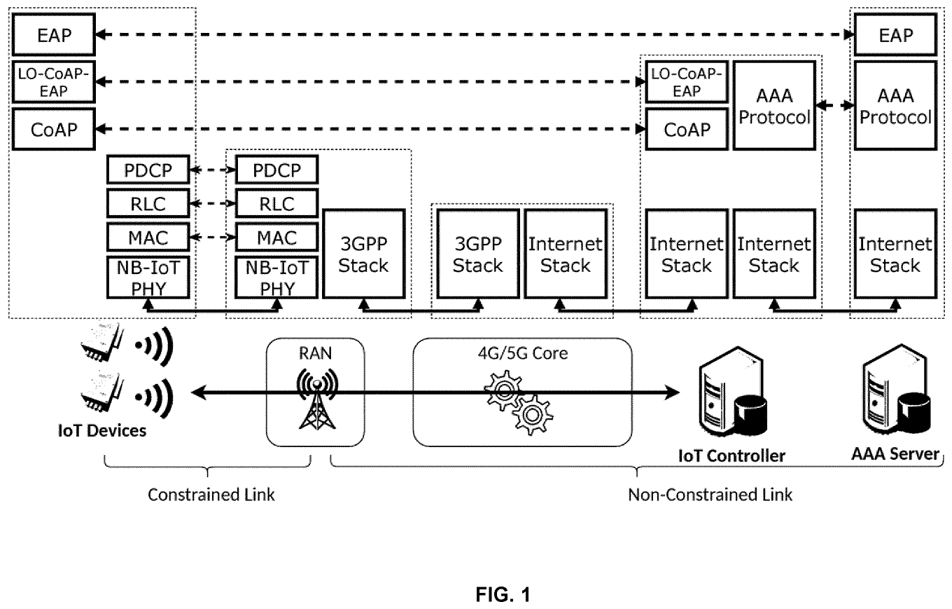

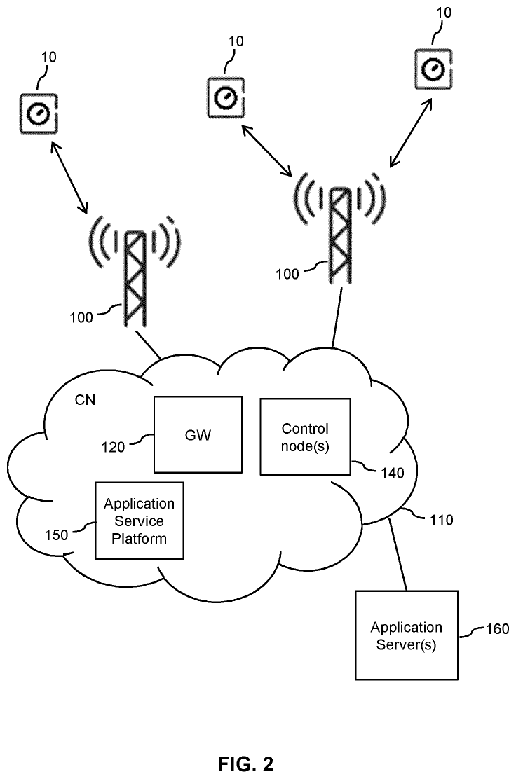

FIG. 1 illustrates exemplary structures of the wireless communication network. In particular, FIG. 1 shows multiple UEs 10 which are served by access nodes 100 of the wireless communication network. Here, it is noted that each access node 100 may serve a number of cells within the coverage area of the wireless communication network. Depending on the supported RAT(s) each access nodes 100 may correspond to a gNB of the NR technology or an eNB of the LTE technology. The access nodes 100 may each be regarded as being part of an RAN of the wireless communication network. Further, FIG. 1 schematically illustrates a CN (Core Network) 110 of the wireless communication network. In FIG. 1, the CN 110 is illustrated as including a GW (gateway) 120 and one or more control node(s) 140. The GW 120 may be responsible for handling user plane data traffic of the UEs 10, e.g., by forwarding user plane data traffic from a UE 10 to a network destination or by forwarding user plane data traffic from a network source to a UE 10. Here, the network destination may correspond to another UE 10, to an internal node of the wireless communication network, or to an external node which is connected to the wireless communication network. Similarly, the network source may correspond to another UE 10, to an internal node of the wireless communication network, or to an external node which is connected to the wireless communication network. The GW may for example correspond to a UPF (User Plane Function) of the 5G Core (EGC) or to an SGW (Serving Gateway) or PGW (Packet Data Gateway) of the 4G EPC (Evolved Packet Core). The control node(s) 140 may be used for controlling the user data traffic, e.g., by providing control data to the access node 100, the GW 120, and/or to the UE 10. Such control data may in particular have the purpose of configuring the above-mentioned utilization of the early acknowledgement message. The UEs 10 of FIG. 1 are illustrated as MTC devices, e.g., M2M devices or NB-IoT devices like sensors, metering devices, industrial machinery, home or personal appliances, or personal wearables. It is however noted that other types of UEs 10 could be present in addition or as an alternative, e.g., smartphones, portable computers, stationary computers, vehicle-based UEs, or the like.

As illustrated by double-headed arrows, the access node 100 may send downlink (DL) transmissions to the UEs, and the UEs may send uplink (UL) transmissions to the access nodes 100. The DL transmissions and UL transmissions may be used to provide various kinds of services to the UEs, e.g., a voice service, a multimedia service, or a data service. Such services may be hosted in the CN 110, e.g., by a corresponding network node. By way of example, FIG. 1 illustrates an application service platform 150 provided in the CN 110. Further, such services may be hosted externally, e.g., by an AF (application function) connected to the CN 110. By way of example, FIG. 1 illustrates one or more application servers 160 connected to the CN 110. The application server(s) 160 could for example connect through the Internet or some other wide area communication network to the CN 110. The application service platform 150 may be based on a server or a cloud computing system and be hosted by one or more host computers. Similarly, the application server(s) 160 may be based on a server or a cloud computing system and be hosted by one or more host computers. The application server(s) 160 may include or be associated with one or more AFs that enable interaction with the CN 110 to provide one or more services to the UEs 10, corresponding to one or more applications. These services or applications may generate the user data traffic conveyed by the DL transmissions and/or the UL transmissions between the access node(s) 100 and the respective UE 10. Accordingly, the application server(s) 160 may include or correspond to the above-mentioned network destination and/or network source for the user data traffic. In the respective UE 10, such service may be based on an application (or shortly “app”) which is executed on the UE 10. Such application may be pre-installed or installed by the user. Such application may generate at least a part of the UP traffic between the UE 10 and the access node 100.

In the illustrated concepts, a network function may assist in efficient delivery of the UL user plane data from the UE 10 to a destination device. Such destination device may be an application server, e.g., such as the application server 160, another UE 10, or some other device. In accordance with the above-described functionalities of the network node in the illustrated concepts, the network function is herein also denoted as “proxy function” (PF). The PF may be implemented in a user-plane node of the CN 110, such as the above-mentioned GW 120. The PF acts as an intermediary between the UE 10 and the destination device, splitting E2E connectivity of the UE 10 into a first path between the UE 10 and the PF and a second path between the PF and the destination device.

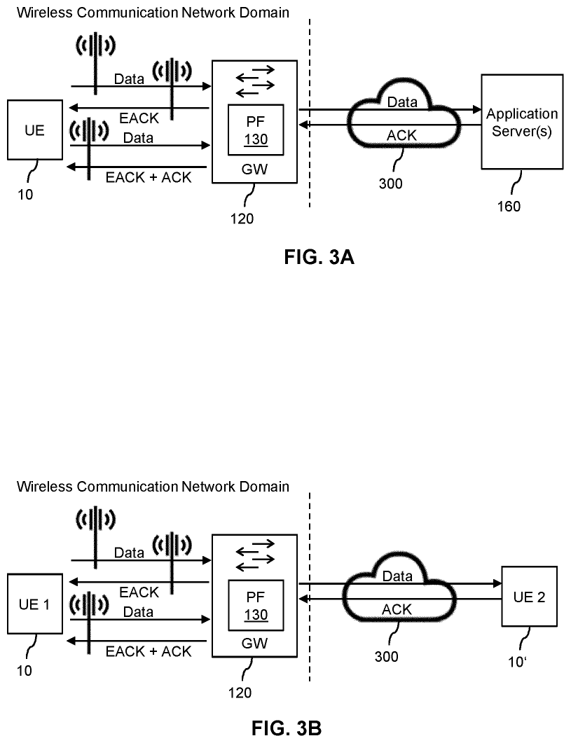

FIG. 3A illustrates an example in which the PF 130 is used in delivery of data from a UE 10 to an application server 160. In this example, the PF 130 is implemented in a GW 120, e.g., a UPF, SGW, or PGW. The application server 160 is assumed to be arranged outside the domain of the mobile communication network. As illustrated, the application server 160 is connected by a data network 300, e.g., the Internet, to the mobile communication network.

In the example of FIG. 3A, the UE 10 sends data via the GW 120 and the data network 300 to the application server 160. The itself data can be encrypted and thus not decipherable by the GW 120 or the PF 130. The PF 130 in the GW 120 buffers the data received from the UE 10 and forwards the received data via the data network 300 to the application server 160. Further, upon receipt of the data, the PF 130 also sends an early acknowledgement (EACK) message back to the UE 10. The EACK message indicates to the UE 10 that the PF 130 will handle the delivery of the data to the application server 160 on behalf of the UE 10. After receiving the EACK message, the UE 10 may enter an energy-saving mode to save energy, e.g., according to a DRX (Discontinuous Reception) configuration or by using other energy-saving functionalities, which may involve that the UE 10 temporarily and/or partially disconnects from the wireless communication network. In the illustrated example, handling the delivery of the data to the application server 160 on behalf of the UE 10 specifically includes functionalities of a retransmission protocol used in E2E connectivity between the UE 10 and the application server 160. In the example of FIG. 3A, this means that the PF 130 waits until it receives a regular acknowledgement (ACK) message from the application server 160. The regular ACK message indicates that the data were successfully received by the application server 160. Upon receiving the regular ACK message, the PF 130 deletes the previously buffered data. Further, the PF 130 also forwards the regular ACK message to the UE 10.

As further illustrated, the sending of the EACK message to the UE 10 may also be coordinated with other messages sent to the UE 10, to thereby avoid signaling overhead and allow the UE 10 to better exploit energy saving by entering the energy-saving mode. In the example of FIG. 3A, the UE 10 sends a further transmission of data via the GW 120 and the data network 300 to the application server 160, and the PF 130 responds with a further EACK message to the UE 10. For better efficiency, the PF 130 sends the further EACK message in the same transmission to the UE 10 which also forwards the regular ACK message from the application server 160.

FIG. 3B illustrates a further example in which the PF 130 is used in delivery of data from a UE 10 to another UE 10′. In this example, the PF 130 is implemented in a GW 120, e.g., a UPF, SGW, or PGW. The other UE 10′ is assumed to be arranged outside the domain of the mobile communication network. As illustrated, the other UE 10′ is connected by a data network 300, e.g., the Internet, to the mobile communication network. For example, the other UE 10′ could be connected to another mobile communication network.

In the example of FIG. 3B, the UE 10 sends data via the GW 120 and the data network 300 to the other UE 10′. The itself data can be encrypted and thus not decipherable by the GW 120 or the PF 130. The PF 130 in the GW 120 buffers the data received from the UE 10 and forwards the received data via the data network 300 to the other UE 10′. Further, upon receipt of the data, the PF 130 also sends an early acknowledgement (EACK) message back to the UE 10. The EACK message indicates to the UE 10 that the PF 130 will handle the delivery of the data to the other UE 10′ on behalf of the UE 10. After receiving the EACK message, the UE 10 may enter an energy-saving mode to save energy, e.g., according to a DRX configuration or by using other energy saving functionalities, which may involve that the UE 10 temporarily and/or partially disconnects from the wireless communication network. In the illustrated example, handling the delivery of the data to the other UE 10′ on behalf of the UE 10 specifically includes functionalities of a retransmission protocol used in E2E connectivity between the UE 10 and the other UE 10′. In the example of FIG. 3B, this means that the PF 130 waits until it receives a regular acknowledgement (ACK) message from the other UE 10′. The regular ACK message indicates that the data were successfully received by the other UE 10′. Upon receiving the regular ACK message, the PF 130 deletes the previously buffered data. Further, the PF 130 also forwards the regular ACK message to the UE 10.

As further illustrated, the sending of the EACK message to the UE 10 may also be coordinated with other messages sent to the UE 10, to thereby avoid signaling overhead and allow the UE 10 to better exploit energy saving by entering the energy-saving mode. In the example of FIG. 3B, the UE 10 sends a further transmission of data via the GW 120 and the data network 300 to the other UE 10′, and the PF 130 responds with a further EACK message to the UE 10. For better efficiency, the PF 130 sends the further EACK message in the same transmission to the UE 10 which also forwards the regular ACK message from the other UE 10′.

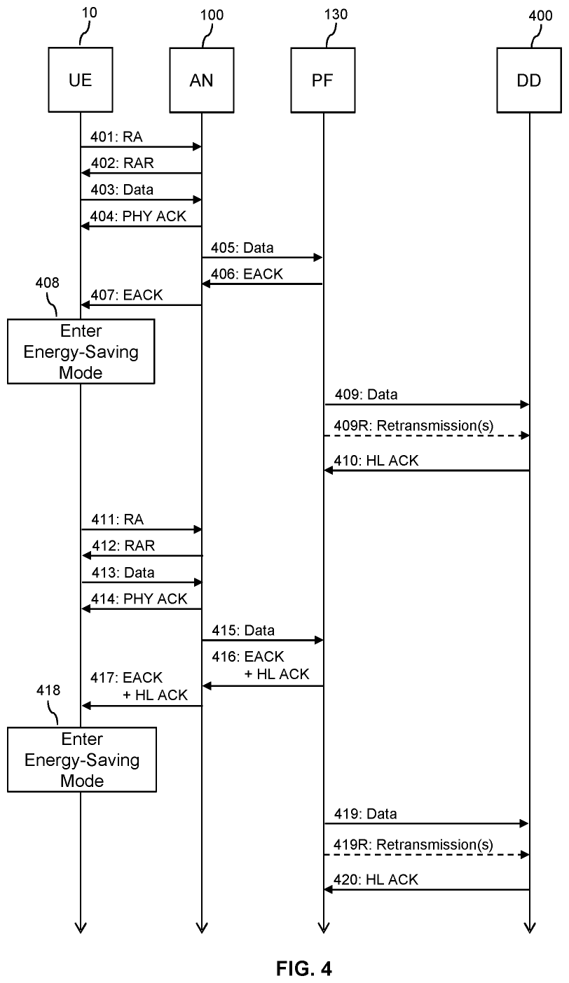

FIG. 4 illustrates exemplary processes based on utilization of the EACK message of the illustrated concepts. The processes of FIG. 4 involve a UE 10, an access node (AN) 100, a PF 130, and a destination device (DD) 400. The UE 10 can correspond to any of the above-mentioned types of WD, e.g., an MTC or IoT device. The DD 400 can be an application server, e.g., like the above-mentioned application server 160, or another WD, e.g., another MTC or IoT device. The AN 100 can for example correspond to a gNB of the 5G NR technology or to an eNB of the 4G LTE technology. The PF 130 can be implemented in a GW, e.g., in a UPF of the 5GC, or an SGW or a PGW of the EPC. However, implementation of the PF 130 in other types of user plane nodes would be possible as well, e.g., in a radio edge application server in the RAN part of the wireless communication network.

In the processes of FIG. 4, it is assumed that the UE 10 sends UL user plane data according to a sparse pattern to the DD 400. For energy saving reasons, the UE 10 enters an energy-saving mode after each occasion of sending UL user plane data. The energy-saving mode can for example be a sleep mode in which the UE 10 deactivates part of its circuitry and/or a disconnected mode in which the UE 10 does not maintain an active connection to the wireless communication network. The energy-saving mode may for example be based on DRX functionalities or on the UE power saving mode as for example specified in 3GPP TS 23.682 V17.1.0 (2021-09). During such occasion of sending UL user plane data, the UE 10 is can also receive DL user plane data. The occasions of sending UL user plane data may for example be based on a DRX configuration of the UE 10.

In the example of FIG. 4, the UE 10 leaves the energy-saving mode to send UL user plane data to the DD 400. This involves that the UE 10 initiates establishment of a radio connection to the wireless communication network, by sending a random access (RA) message 401 to the AN 100. The AN 100 replies to the RA message 401 by sending a RA response (RAR) 402 which includes an allocation of UL radio resources for the UE 10. Using these allocated UL radio resources, the UE 10 then sends a wireless transmissions 403 including the UL user plane data to the AN 100. The AN 100 acknowledges successful reception of the wireless transmission 413 by sending a physical layer (PHY) ACK 404 to the UE 10.

The AN 100 then forwards the UL user plane data from the wireless transmission 403 to the GW implemented with the PF 130, as indicated by message 405. The 130 buffers the UL user plane data and sends an EACK via the AN 100 to the UE 10, as illustrated by messages 406 and 407. The EACK indicates to the UE 10 that the PF 130 will handle the delivery of the UL user plane data to the DD 400, which specifically includes taking over retransmission functionalities of higher protocol layers that otherwise would need to be performed by the UE 10. Upon reception of the EACK, the UE 10 may thus suspend operation related to the retransmission functionalities of higher protocol layers and enter the energy-saving mode, as indicated by block 408.

The PF 130 forwards the UL user plane data to the DD 400, as indicated by message 409. This forwarding may involve transfer of the UL user plane data through various nodes and data networks, e.g., the Internet, and bear the risk of data loss. Accordingly, if needed the PF 130 may also perform one or more retransmissions of the UL user plane data, as indicated by 409R. Such retransmission(s) may for example be triggered by the PF 130 not receiving a higher layer (HL) ACK from the DD 400. The HL ACK may for example be part of a retransmission functionality of an E2E communication protocol between the UE 10 and the DD 400, as for example defined in an E2E transport protocol or E2E application protocol. The forwarding of the UL user plane data and any required retransmission(s) may be performed while the UE 10 is in the energy-saving mode.

In the example of FIG. 4, it is assumed that the PF 130 at some point receives a HL ACK from the DD 400, as indicated by message 410. In response to the HL ACK, the PF 130 may delete the successfully transferred UL user plane data from its buffer. Further, the PF 130 buffers the HL ACK for forwarding to the UE 10 at the next occasion when the UE 10 is reachable for DL wireless transmissions.

At some point, the UE 10 again wakes up from the energy-saving mode to send further UL user plane data to the DD 400. This involves that the UE 10 again initiates establishment of a radio connection to the wireless communication network, by sending a RA message 411 to the AN 100. The AN 100 replies to the RA message 411 by sending a RAR 412 which includes an allocation of UL radio resources for the UE 10. Using these allocated UL radio resources, the UE 10 then sends a wireless transmissions 413 including the further UL user plane data to the AN 100. The AN 100 acknowledges successful reception of the wireless transmission 413 by sending a PHY ACK 414 to the UE 10.

The AN 100 then forwards the further UL user plane data from the wireless transmission 413 to the GW implemented with the PF 130, as indicated by message 415. The 130 buffers the further UL user plane data and sends a further EACK via the AN 100 to the UE 10, as illustrated by messages 416 and 417. The EACK indicates to the UE 10 that the PF 130 will handle the delivery of the UL user plane data to the DD 400, which specifically includes taking over retransmission functionalities of higher protocol layers that otherwise would need to be performed by the UE 10. In view of resource efficiency, the PF 130 uses the message conveying the further EACK to also forward the HL ACK from the DD 400 to the UE 10. Upon reception of the further EACK, the UE 10 may thus suspend operation related to the retransmission functionalities of higher protocol layers and reenter the energy-saving mode, as indicated by block 418. Further, the UE 10 is informed by the HL ACK that the UL user plane data of the earlier wireless transmission 403 were successfully transferred to the DD 400.

As further illustrated, the PF 130 also forwards the further UL user plane data to the DD 400, as indicated by message 419. In some cases, the PF 130 may detect that the further UL user plane data is identical to the UL user plane data previously received in message 405. If in such case the previously received UL user plane data was not yet successfully transferred to the DD 400, the PF 130 may discard one instance of the identical UL user plane data, rather than forwarding it to the DD 400. In some cases, the PF 130 could also detect that the further UL user plane data is an updated version of the UL user plane data previously received in message 405. If in such case the previously received UL user plane data was not yet successfully transferred to the DD 400, the PF 130 may replace the previously received UL user plane data with the updated version. In some cases, the PF 130 also perform one or more retransmissions of the UL user plane data, as indicated by 419R. At some point, the further UL user plane data are successfully transferred to the DD 400, and the DD 400 replies by sending a further HL ACK, as indicated by message 420. In response to the further HL ACK, the PF 130 may delete the successfully transferred further UL user plane data from its buffer. Further, the PF 130 buffers the further HL ACK for forwarding to the UE 10 at the next occasion when the UE 10 is reachable for DL wireless transmissions.

It is noted that in the processes of FIG. 4, the PF 130 does not require further access to the content of the UL user plane data transferred to the DD 400. Accordingly, the illustrated processes can also be performed when using E2E encryption of the user plane data between the UE 10 and the DD 400. Further, it is noted that in addition or as an alternative to triggering the retransmission(s) by absence of an expected HL ACK, the retransmission(s) could also be triggered by a HL negative ACK from the DD 400, explicitly indicating that the UL user plane data was not successfully received by the DD 400.

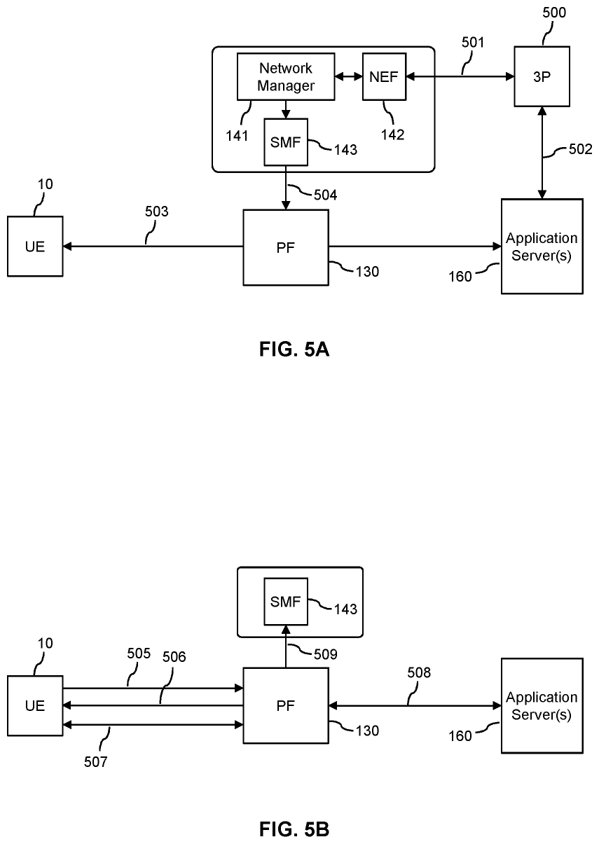

FIGS. 5A and 5B further illustrate an example of user plane and control plane interaction when establishing and utilizing the above-described functionalities of the PF 130. In this example, a 5G architecture of the wireless communication network is assumed. Further, it is assumed that the functionality of the PF 130 is made available based on an SLA (Service Level Agreement) with a third party (3P) entity 500. In some case, the functionality of the PF 130 could also be made available for only certain slices of the wireless communication network and/or for only a certain set of UEs.

FIG. 5A shows an example of signaling that may be used to make the PF 130 discoverable for UEs 10. This may be achieved by a network manager 141 informs the 3P entity 500 about the possibility to utilize the functionality of the PF 130, e.g., by offering a service of having an in-network anchor point for IoT devices. This exposure of an available network service is illustrated by signalling 501 and may be done through an NEF (Network Exposure Function) 142. The 3P entity 500 then agrees to utilize the network service and informs the application server 160 accordingly, as indicated by signaling 502. For example, the 3P entity 500 may inform the application server 160 about the IP (Internet Protocol) address and port of the PF 130. The application server 160 may further indicate corresponding information to the UEs 10 which are allowed to utilize the network service and to the PF 130, as indicated by signaling 503. Further, the network manager 141 also provides control signaling 504 through an SMF 143 to the PF 130, e.g., for authorizing utilization of the network service by the application server 160 and the considered set of UEs. As a result, the UEs 10 of the set will be informed about the presence of the PF 130 as intermediate destination for the user plane data transmitted to the application server 160. Based on these preparations, setup of a communication session by a certain UE 10 may be performed as illustrated in FIG. 5B.

As shown by message 505, the UE 10 requests establishment of a connection with the PF 130, and the PF 130 confirms establishment of the connection by sending message 506 to the UE 10. After that, the PF 130 can start performing the above-described functionalities of assisting in delivery of user plane data to the application server 160, i.e., will act as anchor point for the user plane traffic between the UE 10 and the application server 160. As a result, the UE 10 would send the user plane data first to the PF 130, which responds with the EACK message, as illustrated by signaling 507. The PF 130 in turn relays the user plane data to the application server 160, as indicated by signaling 508. As further illustrated by message 509, the PF 130 can also provide control signaling to the SMF 143, or to other control plane nodes, e.g., to notify the control plane about statistics or other information concerning the user plane traffic handled by the PF 130.

It is noted that the functionalities of the PF 130 can also go beyond handling the delivery of the data on behalf of the UE 10: In some scenarios the PF 130 could analyze the forwarded data to collect information which may be valuable for other network functionalities or services, e.g., for enforcing traffic policies or the like. For example, while in encrypted E2E protocols like QUIC (IETF RFC 9000), content of the retransmission packets and packet numbers would be hidden from the PF 130, the PF 130 could infer from a trend of connections from a certain UE 10 if the source needs a new communication policy to ensure desired Quality of Service attributes. Further, the PF 130 could also assist in shaping peak access demand. When considering that the application server 160 is designed based on a certain estimated the peak access demand to the application server 160, the PF 130 can schedule the forwarding of the user plane data to the application server 160 in such a way that the peak access demand is not exceeded. In this way, overprovisioning the application server 160 can be avoided or at least reduced.

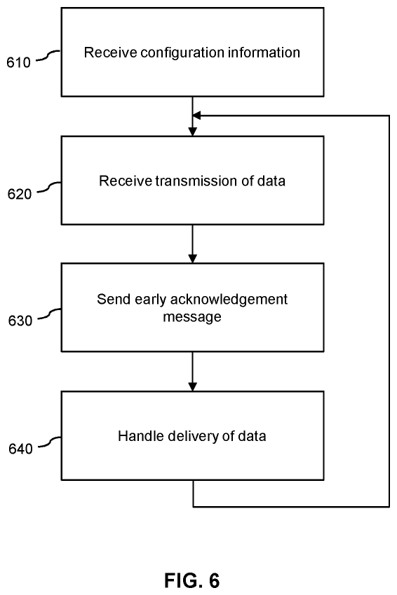

FIG. 6 shows a flowchart for illustrating a method, which may be utilized for implementing the illustrated concepts. The method of FIG. 6 may be used for implementing the illustrated concepts in a node of a wireless communication network. The node may be a user plane node of the wireless communication network and/or may be arranged in a core network part of the wireless communication network. For example, the node may correspond to the above-mentioned GW 120 or some other node implementing the above-mentioned functionalities of the PF 130.

If a processor-based implementation of the node is used, at least some of the steps of the method of FIG. 6 may be performed and/or controlled by one or more processors of the node. Such node may also include a memory storing program code for implementing at least some of the below described functionalities or steps of the method of FIG. 6.

At step 610, the node may receive configuration information. The node may receive the configuration information from another node of the wireless communication network, e.g., from a control plane node, such as the above-mentioned control node(s) 140, network manager 141, or SMF 143. The control information may have the purpose of configuring the node with respect to sending of early acknowledgement messages and handling delivery of data on behalf of wireless devices. The configuration information may activate certain functionalities of the node, as further defined in steps 620, 630, and/or 640 or indicate a set of wireless devices and/or end devices for which these functionalities shall be available. The activation may be based on a SLA. In some cases, the activation can also be per network slice.

At step 620, the node receives a transmission of data from a wireless device, such as one of the above-mentioned UEs. The wireless device can be an IoT device or MTC device. The data is destined to a destination device. In some scenarios, the data may be encrypted using E2E encryption between the wireless device and the destination device. The destination device can be an application server. Alternatively, the destination device could be another wireless device, e.g., another IoT device or MTC device.

At step 630, the node sends an early acknowledgement message to the wireless device. The early acknowledgement message indicates that the node will handle delivery of the data to a destination device on behalf of the wireless device.

At step 640, the node may handle the delivery of the data on behalf of the wireless device, The handling of delivery at step 640, may include forwarding the data to the destination device and, in response to determining that the data was not successfully received by the destination device, retransmitting the data to the destination device. Determining that the data was not successfully received by the destination device may be based on acknowledgement feedback from the destination device. In some cases, the acknowledgement feedback from the destination device may include a negative acknowledgement message indicating that the data was not successfully received by the destination device. In other cases, the acknowledgement feedback from the destination device may be based on absence of a positive acknowledgement message indicating that the data was successfully received by the destination device. The early acknowledgement message may cause the wireless device to enter a energy-saving mode.

In some scenarios, the handling of the delivery may involve that the node receives a positive acknowledgement message from the destination device, the positive acknowledgement message indicating that the data was successfully received by the destination device. In this case, the handling of delivery may further involve that the node forwards the positive acknowledgement message to the wireless device.

The method of FIG. 6 may be iterated, by returning to step 620 to receive a transmission of further data from the wireless device. At step 630, the node would then send a further early acknowledgement message to the wireless device, the further early acknowledgement message indicating that the node will handle delivery of the further data to the destination device on behalf of the wireless device. In such case, the further early acknowledgement message may be conveyed together with a forwarded positive acknowledgement message from the destination device. In particular, the forwarded positive acknowledgement message and the further early acknowledgment message may be conveyed in a single wireless transmission to the wireless device.

In some scenarios, when receiving a transmission of further data from the wireless device, the node may detect that the further data is identical to previously received data, which was not yet being successfully delivered to the destination device. In such cases, the node may discard the received further data.

In some scenarios, when receiving a transmission of further data from the wireless device, the node may detect that the further data is an updated version of previously received data, which was not yet being successfully delivered to the destination device. In such cases, the node may replace the previously received data with the further data.

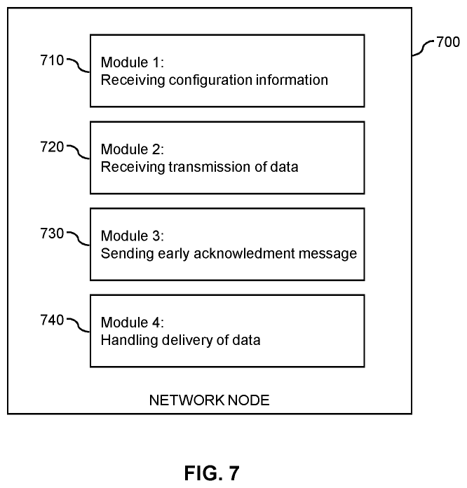

FIG. 7 shows a block diagram for illustrating functionalities of a node 700 for a wireless communication network which operates according to the method of FIG. 6. The node 700 may for example correspond to the above-mentioned GW 120 or PF 130. As illustrated, the node 700 may be provided with a module 710 configured to receive configuration information, such as explained in connection with step 610. Further, the node 700 may be provided with a module 720 configured to receive a transmission of data, such as explained in connection with step 620. Further, the node 700 may be provided with a module 730 configured to send an early acknowledgement message, such as explained in connection with step 630. Further, the node 700 may be provided with a module 740 configured to handle delivery of the data to a destination device, such as explained in connection with step 640.

It is noted that the node 700 may include further modules for implementing other functionalities, such as known functionalities of a GW in the 5G NR technology or in the 4G LTE technology and/or a gNB in the NR technology. Further, it is noted that the modules of the node 700 do not necessarily represent a hardware structure of the node 700, but may also correspond to functional elements, e.g., implemented by hardware, software, or a combination thereof.

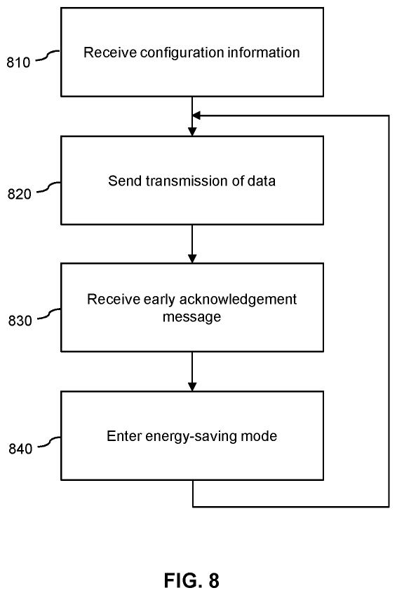

FIG. 8 shows a flowchart for illustrating a method, which may be utilized for implementing the illustrated concepts. The method of FIG. 8 may be used for implementing the illustrated concepts in a wireless device, e.g., corresponding to any of the above-mentioned UEs 10. The wireless device may be an IoT device or MTC device.

If a processor-based implementation of the wireless device is used, at least some of the steps of the method of FIG. 8 may be performed and/or controlled by one or more processors of the wireless device. Such wireless device may also include a memory storing program code for implementing at least some of the below described functionalities or steps of the method of FIG. 8.

At step 810, the wireless device may receive configuration information. The wireless device may receive the configuration information from a node of the wireless communication network, e.g., from a control plane node, such as the above-mentioned control node(s) 140, network manager 141, or SMF 143. A part of the configuration information could also be received from a communication endpoint of the wireless device, such as the above-mentioned application server. The control information may have the purpose of configuring the wireless device with respect to receiving of early acknowledgement messages depending on the reception of such early acknowledgement message. The configuration information may activate certain functionalities of the wireless device, as further defined in steps 820, 830, and/or 840, or may indicate a node of the wireless communication network which shall act as an intermediary for communication of the wireless device with a certain destination device.

At step 820, the wireless device sends a transmission of data through the wireless communication network to a destination device. In some scenarios, the data may be encrypted using E2E encryption between the wireless device and the destination device. The destination device can be an application server. Alternatively, the destination device could be another wireless device, e.g., another IoT device or MTC device.

At step 830, the wireless device receives an early acknowledgement message from a node of the wireless communication network. The early acknowledgement message indicating that the node will handle delivery of the data to the destination device on behalf of the wireless device.

The handling of delivery on behalf of the wireless device, may comprise forwarding the data to the destination device and, in response to determining that the data was not successfully received by the destination device, retransmitting the data to the destination device.

Determining that the data was not successfully received by the destination device may be based on acknowledgement feedback from the destination device. In some cases, the acknowledgement feedback from the destination device may include a negative acknowledgement message indicating that the data was not successfully received by the destination device. In other cases, the acknowledgement feedback from the destination device may be based on absence of a positive acknowledgement message indicating that the data was successfully received by the destination device. The early acknowledgement message may cause the wireless device to enter an energy-saving mode.

In some scenarios, the handling of the delivery may involve that the node receives a positive acknowledgement message from the destination device, the positive acknowledgement message indicating that the data was successfully received by the destination device. In this case, the handling of delivery may further involve that the node forwards the positive acknowledgement message to the wireless device.

At step 840, in response to receiving the early acknowledgement message, the wireless device may enter an energy-saving mode.

The method of FIG. 8 may be iterated, by returning to step 820 to send a transmission of further data to the destination device. At step 830, the wireless device could then receive a further early acknowledgement message from the node, the further early acknowledgement message indicating that the node will handle delivery of the further data to the destination device on behalf of the wireless device. In such case, the further early acknowledgement message may be conveyed together with a forwarded positive acknowledgement message from the destination device. In particular, the forwarded positive acknowledgement message and the further early acknowledgment message may be conveyed in a single wireless transmission to the wireless device.

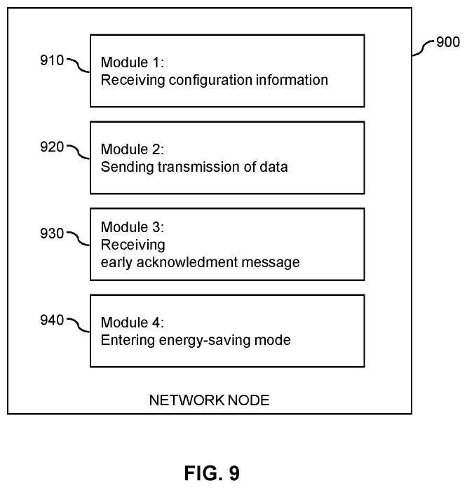

FIG. 9 shows a block diagram for illustrating functionalities of a wireless device 900 which operates according to the method of FIG. 8. The wireless device 900 may for example correspond to any of the above-mentioned UEs 10. As illustrated, the wireless device 900 may be provided with a module 910 configured to receive configuration information, such as explained in connection with step 810. Further, the wireless device 900 device may be provided with a module 920 configured to send a transmission of data, such as explained in connection with step 820. Further, the wireless device 900 may be provided with a module 930 configured to receive an early acknowledgement, such as explained in connection with step 830. Further, the wireless device 900 may be provided with a module 940 configured to enter an energy-saving mode, such as explained in connection with step 840.

It is noted that the wireless device 900 may include further modules for implementing other functionalities, such as known functionalities of a UE in the 5G NR technology and/or the 4G LTE technology. Further, it is noted that the modules of the wireless device 900 do not necessarily represent a hardware structure of the wireless device 900, but may also correspond to functional elements, e.g., implemented by hardware, software, or a combination thereof.

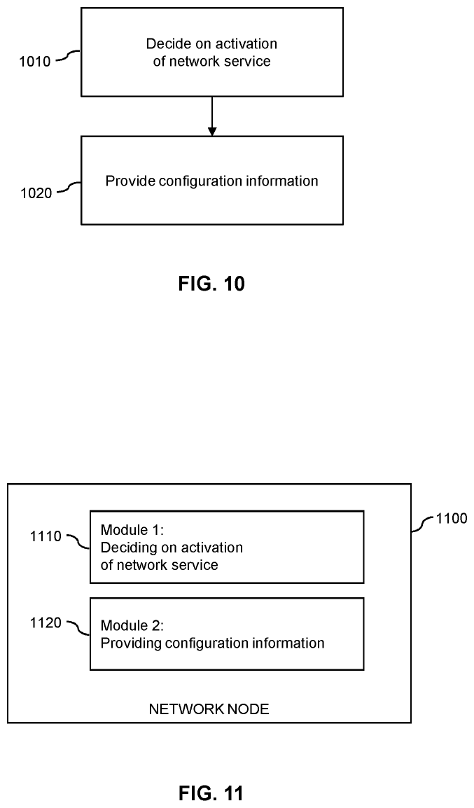

FIG. 10 shows a flowchart for illustrating a method, which may be utilized for implementing the illustrated concepts. The method of FIG. 10 may be used for implementing the illustrated concepts in a node of a wireless communication network. The node may be a control plane node of the wireless communication network and/or may be arranged in a core network part of the wireless communication network. For example, the node may correspond to one of the above-mentioned control nodes 140, to the network manager 141, or to the SMF 143.

If a processor-based implementation of the node is used, at least some of the steps of the method of FIG. 10 may be performed and/or controlled by one or more processors of the node. Such node may also include a memory storing program code for implementing at least some of the below described functionalities or steps of the method of FIG. 10.

At step 1010, the node may decide on activation of a network service. This network service may correspond to or involve to sending of early acknowledgement messages and handling delivery of data on behalf of wireless devices. The wireless devices can be IoT devices or MTC devices. The decision of step 1010 may be based on interaction of the node with a third party entity, such as the 3P entity 500 in FIG. 5A. The decision may be based on a SLA and may be specific for a network slice of the wireless communication network and/specific for a set of wireless devices.

At step 1020, the node sends configuration information. The node may send the configuration information to another node of the wireless communication network, e.g., from a user plane node, such as the above-mentioned GW 120 or PF 130. The control information may have the purpose of configuring the node with respect to sending of early acknowledgement messages and handling delivery of data on behalf of wireless devices. The configuration information may activate certain functionalities of the node, relating sending of early acknowledgement messages and handling delivery of data on behalf of wireless devices, or indicate a set of wireless devices and/or end devices for which these functionalities shall be available. This activation may be based on the decision of step 1010.

The handling of delivery configured by the configuration information may relate to data received data from one of the wireless devices, with the data is destined to a destination device. In some scenarios, the data may be encrypted using E2E encryption between the wireless device and the destination device. The destination device can be an application server. Alternatively, the destination device could be another wireless device, e.g., another IoT device or MTC device. Further, the handling of delivery may include forwarding the data to the destination device and, in response to determining that the data was not successfully received by the destination device, retransmitting the data to the destination device. Determining that the data was not successfully received by the destination device may be based on acknowledgement feedback from the destination device. In some cases, the acknowledgement feedback from the destination device may include a negative acknowledgement message indicating that the data was not successfully received by the destination device. In other cases, the acknowledgement feedback from the destination device may be based on absence of a positive acknowledgement message indicating that the data was successfully received by the destination device. The early acknowledgement message may cause the wireless device to enter an energy-saving mode.

In some scenarios, the handling of the delivery may involve that the node receives a positive acknowledgement message from the destination device, the positive acknowledgement message indicating that the data was successfully received by the destination device. In this case, the handling of delivery may further involve that the node forwards the positive acknowledgement message to the wireless device.

The handling of delivery may be iterated and also involve receiving a transmission of further data from the wireless device. The node would then send a further early acknowledgement message to the wireless device, the further early acknowledgement message indicating that the node will handle delivery of the further data to the destination device on behalf of the wireless device. In such case, the further early acknowledgement message may be conveyed together with a forwarded positive acknowledgement message from the destination device. In particular, the forwarded positive acknowledgement message and the further early acknowledgment message may be conveyed in a single wireless transmission to the wireless device. In some scenarios, when receiving a transmission of further data from the wireless device, the node may detect that the further data is identical to previously received data, which was not yet being successfully delivered to the destination device. In such cases, the node may discard the received further data. In some scenarios, when receiving a transmission of further data from the wireless device, the node may detect that the further data is an updated version of previously received data, which was not yet being successfully delivered to the destination device. In such cases, the node may replace the previously received data with the further data.

FIG. 11 shows a block diagram for illustrating functionalities of a node 1100 for a wireless communication network which operates according to the method of FIG. 10. The node 1100 may for example correspond to the above-mentioned control node(s) 140, network manager 141 or SMF 143. As illustrated, the node 1100 may be provided with a module 1110 configured to decide on activation of a network service, such as explained in connection with step 1010. Further, the node 1100 may be provided with a module 1120 configured to send configuration information, such as explained in connection with step 1020.

It is noted that the node 1100 may include further modules for implementing other functionalities, such as known functionalities of a control node in the 5G NR technology or in the 4G LTE technology. Further, it is noted that the modules of the node 1100 do not necessarily represent a hardware structure of the node 1100, but may also correspond to functional elements, e.g., implemented by hardware, software, or a combination thereof.

It is to be understood that the functionalities as described in connection with FIGS. 6 to 11 may also be combined in various ways, e.g., in a system which includes at least one node operating according to the method of FIG. 6 and at least one wireless device operating according to the method of FIG. 8. Further, such system could include at least one node operating according to the method of FIG. 10.

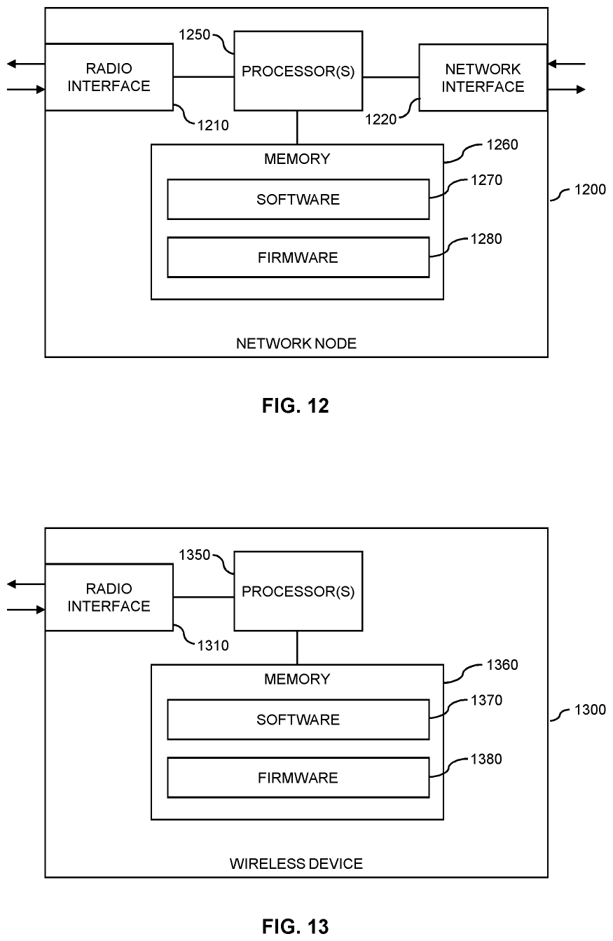

FIG. 12 illustrates a processor-based implementation of a node 1200 for a wireless communication network, which may be used for implementing the above-described concepts. For example, the structures as illustrated in FIG. 12 may be used for implementing the concepts in a user plane node, such as the above-mentioned GW 120 or PF 130. Further, the structures as illustrated in FIG. 12 may be used for implementing the concepts in a control plane node, such as the above-mentioned control nodes 140, network manager 141 or SMF 143.

As illustrated, the node 1200 may include one or more radio interfaces 1210. The radio interface(s) 1210 may for example be based on the NR technology or the LTE technology. The radio interface(s) 1210 may be used for connecting to wireless devices, such as any of the above-mentioned UEs 10. Further, the node 1200 may include one or more network interfaces 1220. The network interface(s) 1220 may for example be used for communication with one or more other nodes of the wireless communication network.

Further, the node 1200 may include one or more processors 1250 coupled to the interface(s) 1210, 1220 and a memory 1260 coupled to the processor(s) 1250. By way of example, the interface(s) 1210, 1220, the processor(s) 1250, and the memory 1260 could be coupled by one or more internal bus systems of the node 1200. The memory 1260 may include a read-only memory (ROM), e.g., a flash ROM, a random-access memory (RAM), e.g., a dynamic RAM (DRAM) or static RAM (SRAM), a mass storage, e.g., a hard disk or solid state disk, or the like. As illustrated, the memory 1260 may include software 1270 and/or firmware 1280. The memory 1260 may include suitably configured program code to be executed by the processor(s) 1250 so as to implement or configure the above-described functionalities for handling delivery of data, such as explained in connection with FIG. 6 or 10.

It is to be understood that the structures as illustrated in FIG. 12 are merely schematic and that the node 1200 may actually include further components which, for the sake of clarity, have not been illustrated, e.g., further interfaces, such as a dedicated management interface, or further processors. Also, it is to be understood that the memory 1260 may include further program code for implementing known functionalities of a GW or control node in the NR technology or LTE technology. According to some embodiments, also a computer program may be provided for implementing functionalities of the node 1200, e.g., in the form of a physical medium storing the program code and/or other data to be stored in the memory 1260 or by making the program code available for download or by streaming.

FIG. 13 illustrates a processor-based implementation of a wireless device 1300 which may be used for implementing the above-described concepts. For example, the structures as illustrated in FIG. 13 may be used for implementing the concepts in any of the above-mentioned UEs 10.

As illustrated, the wireless device 1300 includes one or more radio interfaces 1310. The radio interface(s) 1310 may for example be based on the NR technology or the LTE technology. The radio interface(s) 1310 may be used for providing connectivity of the wireless device to a wireless communication network, e.g., via one or more access nodes of the wireless communication network, such as the above-mentioned access nodes 100. This connectivity may involve conveying user plane data transmitted to or from the wireless device through one or more user plane nodes of the wireless communication network. Further, such connectivity may be controlled by one or more control plane nodes of the wireless communication network.

Further, the wireless device 1300 may include one or more processors 1350 coupled to the radio interface(s) 1310 and a memory 1360 coupled to the processor(s) 1350. By way of example, the radio interface(s) 1310, the processor(s) 1350, and the memory 1360 could be coupled by one or more internal bus systems of the wireless device 1100. The memory 1360 may include a ROM, e.g., a flash ROM, a RAM, e.g., a DRAM or SRAM, a mass storage, e.g., a hard disk or solid state disk, or the like. As illustrated, the memory 1360 may include software 1370 and/or firmware 1380. The memory 1360 may include suitably configured program code to be executed by the processor(s) 1350 so as to implement the above-described functionalities for handling delivery of data, such as explained in connection with FIG. 8.

It is to be understood that the structures as illustrated in FIG. 13 are merely schematic and that the wireless device 1100 may actually include further components which, for the sake of clarity, have not been illustrated, e.g., further interfaces, such as a dedicated management interface, or further processors. Also, it is to be understood that the memory 1360 may include further program code for implementing known functionalities of a UE. According to some embodiments, also a computer program may be provided for implementing functionalities of the wireless device 1300, e.g., in the form of a physical medium storing the program code and/or other data to be stored in the memory 1360 or by making the program code available for download or by streaming.

As can be seen, the concepts as described above may be used for efficiently managing transmissions of data from a wireless device. Specifically, the illustrated concepts may enable significant energy saving by the wireless device, by allowing the wireless device to delegate certain functionalities to a network node, such as the above-mentioned PF 130. In this way, the wireless device may refrain from continuously monitoring whether certain data were successfully received by the destination device. Further, also the task of triggering and performing retransmissions of the data may be delegated to the network node. As a result, the wireless device can benefit from longer battery lifetime. The illustrated concepts may also help to reduce load in massive access scenarios, by contributing to shortening of access sessions of wireless devices. Still further, the load on application servers can be subject to additional control, thus avoiding exceeding a peak access demand.

It is to be understood that the examples and embodiments as explained above are merely illustrative and susceptible to various modifications. For example, the illustrated concepts may be applied in connection with various kinds of wireless communication technologies. Further, the concepts may be applied with respect to various types of UEs. Further, the concepts may be applied in connection with various E2D protocols, with or without E2E encryption. Moreover, it is to be understood that the above concepts may be implemented by using correspondingly designed software to be executed by one or more processors of an existing device or apparatus, or by using dedicated device hardware. Further, it should be noted that the illustrated apparatuses or devices may each be implemented as a single device or as a system of multiple interacting devices or modules.

1. A method of controlling wireless communication, the method comprising:
a node of a wireless communication network receiving a transmission of data from a wireless device; and
the node sending an early acknowledgement message to the wireless device, the early acknowledgement message indicating that the node will handle delivery of the data to a destination device on behalf of the wireless device.

2. The method according to claim 1,
wherein said handling of delivery comprises:
the node the data to the destination device; and
in response to determining that the data was not successfully received by the destination device, the node retransmitting the data to the destination device.

3. The method according to claim 2,
wherein said determining that the data was not successfully received by the destination device is based on acknowledgement feedback from the destination device.

4. The method according to claim 2,
wherein the acknowledgement feedback from the destination device comprises a negative acknowledgement message indicating that the data was not successfully received by the destination device.

5. The method according to claim 2,
wherein the acknowledgement feedback from the destination device comprises absence of a positive acknowledgement message indicating that the data was successfully received by the destination device.

6. The method according to claim 1,
wherein the early acknowledgement message causes the wireless device to enter an energy-saving mode.

7. The method according to claim 1, comprising:
the node receiving a positive acknowledgement message from the destination device, the positive acknowledgement message indicating that the data was successfully received by the destination device; and
the node forwarding the positive acknowledgement message to the wireless device.

8. The method according to claim 7, comprising:
the node receiving a transmission of further data from the wireless device; and
the node sending a further early acknowledgement message to the wireless device, the further early acknowledgement message indicating that the node will handle delivery of the further data to the destination device on behalf of the wireless device,
wherein the forwarded positive acknowledgement message and the further early acknowledgement are conveyed in a single wireless transmission to the wireless communication device.

9. The method according to claim 1, comprising:
the node receiving a transmission of further data from the wireless device; and
in response to detecting that the further data is identical to the data and the data not yet being successfully delivered to the destination device, the node discarding the further data.

10. The method according to claim 1, comprising:
the node receiving a transmission of further data from the wireless device; and
in response to detecting that the further data is an updated version of the data and the data not yet being successfully delivered to the destination device, the node replacing the data with the further data.

11. The method according to claim 1, comprising:
the node receiving control information for configuring said sending of the early acknowledgement message and handling delivery of the data.

12. The method according to claim 11,
wherein said control information is based on a service level agreement with a third party entity.

13. The method according to claim 1,
wherein the node is a user plane node of the wireless communication network.

14. The method according to claim 1,
wherein the node is arranged in a core network part of the wireless communication network.

15. The method according to claim 1,
wherein the wireless device is an Internet of Things, IoT, device.

16. (canceled)

17. (canceled)

18. A method of controlling wireless communication, the method comprising:
a wireless device sending a transmission of data through a wireless communication network to a destination device; and
the wireless device receiving an early acknowledgement message from a node of the wireless communication network, the early acknowledgement message indicating that the node will handle delivery of the data to the destination device on behalf of the wireless device.

19. The method according to claim 18,
wherein said handling of delivery comprises:
the node forwarding the data to the destination device; and
in response to determining that the data was not successfully received by the destination device, the node retransmitting the data to the destination device.

20. The method according to claim 18, comprising:
in response to receiving the early acknowledgement message, the wireless device entering an energy-saving mode.

21.-27. (canceled)

28. A method of controlling wireless communication, the method comprising:
a node of a wireless communication network providing control information to a further node of the wireless communication network, the control information configuring the further node to:
receive a transmission of data from a wireless device;
send an early acknowledgement message to the wireless device, the early acknowledgement message indicating that the further node will handle delivery of the data to a destination device on behalf of the wireless device.

29.-31. (canceled)

32. A node for a wireless communication network, the node being configured to:
receive a transmission of data from a wireless device; and
send an early acknowledgement message to the wireless device, the early acknowledgement message indicating that the node will handle delivery of the data to a destination device on behalf of the wireless device.

33.-43. (canceled)
